(19) United States
(12) Patent Application Publication
(10) Pub. No.: US 2024/0375575 A1
(43) Pub. Date: Nov. 14, 2024

(54) CARGO SECURING STRAP DEVICES

(71) Applicant: Kent HERMAN, Bend, OR (US)

(72) Inventor: Kent HERMAN, Bend, OR (US)

(21) Appl. No.: 18/403,335

(22) Filed: Jan. 3, 2024

Related U.S. Application Data
(60) Provisional application No. 63/465,165, filed on May 9, 2023.

(51) Int. Cl. B60P 7/08

(52) U.S. Cl. CPC B60P 7/083

(57) ABSTRACT

The present disclosure features cargo securing strap devices and methods of their use. In some implementations the cargo securing strap devices include (a) a ratchet buckle comprising a body, mounted on a first side of the body, a mandrel having an axially extending slot and a ratchet/pawl mechanism, and, mounted on a second side of the body, an elongated rear bracket; (b) a first cam buckle having a camming mechanism at a first end and a back rail at a second end; and (c) a loop of webbing, threaded through the slot in the mandrel of the ratchet buckle and around the back rail of the first cam buckle and secured so that the webbing is permanently threaded around the mandrel of the ratchet buckle and around the back rail of the cam buckle, and the ratchet buckle and first cam buckle are thereby permanently connected.

### RELATED APPLICATION

This application claims priority from U.S. Provisional Application No. 63/465,165, filed May 9, 2023, the entire disclosure of which is incorporated herein by reference.

### BACKGROUND

Generally, ratchet straps include a ratchet mechanism having a rotating mandrel to which ratchet wheels are attached. The ratchet wheels are configured to releasably engage a pawl mechanism, and the mandrel includes an axially extending slot through which a webbing strap is threaded.

Current ratchet straps are problematic in several ways, including difficulty in proper threading and violent release of tension when unloading. Adjusting the location of the ratchet on a load to be secured is generally not possible, leading to difficulty in tightening the ratchet strap (for example if the ratchet is located on a corner of the load) and potential damage to the load. Furthermore, improper use of the ratchet can lead to insecure or loose loads.

Other devices for securing cargo, such as ropes and chains, are time-consuming and can damage cargo, and cam buckle straps are typically difficult to tighten sufficiently to provide a secure enough hold.

### SUMMARY

The present disclosure features cargo securing strap devices that include a ratchet mechanism, a webbing strap permanently secured to the ratchet mechanism by a sewn loop that is threaded through the mandrel slot of the ratchet mechanism, and a cam buckle that is attached to the webbing strap.

In one aspect, the present disclosure features a cargo securing strap device comprising (a) a ratchet buckle comprising a body, a mandrel having an axially extending slot and a ratchet/pawl mechanism mounted on a first side of the body, and an elongated rear bracket mounted on a second side of the body; (b) a first cam buckle having a camming mechanism at a first end and a back rail at a second end; and (c) a loop of webbing, threaded through the slot in the mandrel of the ratchet buckle and around the back rail of the first cam buckle and secured so that the webbing is permanently threaded around the mandrel of the ratchet buckle and around the back rail of the cam buckle, and the ratchet buckle and first cam buckle are thereby permanently connected.

Some implementations of the device include one or more of the following features. The loop of webbing may be secured by stitching. The stitching may be disposed between the ratchet buckle and the cam buckle. The stitching may be configured to provide a portion of webbing of fixed length that can be wrapped around the mandrel during use. The portion of webbing that can be wrapped around the mandrel during use may have a length between 3 and 6 inches.

The device may further include a second cam buckle and a second loop of webbing, the second loop of webbing being threaded through the elongated rear bracket of the ratchet buckle and a back rail of the second cam buckle and secured so that the second loop of webbing is permanently threaded through the elongated rear bracket of the ratchet buckle and around the back rail of the second cam buckle, and the ratchet buckle and second cam buckle are thereby permanently connected. A length of webbing may be threaded through the camming mechanism of the first cam buckle. The length of webbing may include an end attachment configured to secure the length of webbing to an attachment point. The end attachment may be, for example, a fastening device selected from the group consisting of loops, hooks, rings, and fasteners configured to be attached to rails or other attachment points.

When two cam buckles are used, the device may include a first length of webbing threaded through the camming mechanism of the first cam buckle and a second length of webbing threaded through the camming mechanism of the second cam buckle.

Each length of webbing may include an end attachment configured to secure the length of webbing to an attachment point, e.g., a fastening device selected from the group consisting of loops, hooks, rings, and fasteners configured to be attached to rails or other attachment points. The end attachments on the two lengths of webbing can be the same or different.

In a further aspect, the disclosure features a cargo securing strap device comprising: (1) a pair of devices, each device comprising (a) a ratchet buckle comprising a body, mounted on a first side of the body, a mandrel having an axially extending slot and a ratchet/pawl mechanism mounted on a first side of the body, and an elongated rear bracket mounted on a second side of the body; (b) a first cam buckle having a camming mechanism at a first end and a back rail at a second end; and (c) a loop of webbing, threaded through the slot in the mandrel of the ratchet buckle and around the back rail of the first cam buckle and secured so that the webbing is permanently threaded around the mandrel of the ratchet buckle and around the back rail of the cam buckle, and the ratchet buckle and first cam buckle are thereby permanently connected; and (2) a length of webbing permanently connected at a first end to the rear bracket of the ratchet buckle of one of the devices, and permanently connected at a second end to the rear bracket of the ratchet buckle of the other device, joining the devices such that the ratchet/pawl mechanisms of the devices face away from each other.

In another aspect, the disclosure features a method of securing a cargo load, the method comprising: (1) providing a cargo securing strap device comprising: (a) a ratchet buckle comprising a body, a mandrel having an axially extending slot and a ratchet/pawl mechanism mounted on a first side of the body, and an elongated rear bracket mounted on a second side of the body; (b) a first cam buckle having a camming mechanism at a first end and a back rail at a second end; (c) a first loop of webbing, threaded through the slot in the mandrel of the ratchet buckle and around the back rail of the first cam buckle and secured so that the webbing is permanently threaded around the mandrel of the ratchet buckle and around the back rail of the cam buckle, and the ratchet buckle and first cam buckle are thereby permanently connected; (d) a second cam buckle having a camming mechanism at a first end and a back rail at a second end; and (e) a second loop of webbing, the second loop of webbing being threaded through the elongated rear bracket of the ratchet buckle and a back rail of the second cam buckle and secured so that the second loop of webbing is permanently threaded through the elongated rear bracket of the ratchet buckle and around the back rail of the second cam buckle, and the ratchet buckle and second cam buckle are thereby permanently connected; (2) threading a first length of webbing through the camming mechanism of the first cam buckle; (3) threading a second length of webbing through the camming mechanism of the second cam buckle; (4) securing ends of the first and second lengths of webbing to attachment points at either side of a cargo to be secured; (5) removing slack from the first and second lengths of webbing by tightening them through the first and second camming mechanisms; and (6) tightening the load using the ratchet mechanism of the ratchet buckle.

Some implementations of the method may include one or more of the following features. The first and second lengths of webbing may include end attachments and the securing step may include attaching the end attachments to the attachment points. The method may further include adjusting the location of the ratchet buckle on the cargo load by tightening and/or loosening the cam buckles. The method may further include releasing the load by releasing tension from one or both of the lengths of webbing using the camming mechanisms.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of a cargo securing strap device according to one implementation.

FIG. 2 is a perspective view of a cargo securing strap device according to another implementation.

FIG. 3 is an enlarged detail perspective view showing the attachment of a webbing strap to the pawl side of the ratchet buckle.

FIG. 4 is an enlarged detail perspective view showing the attachment of a webbing strap to the opposite side of the ratchet buckle.

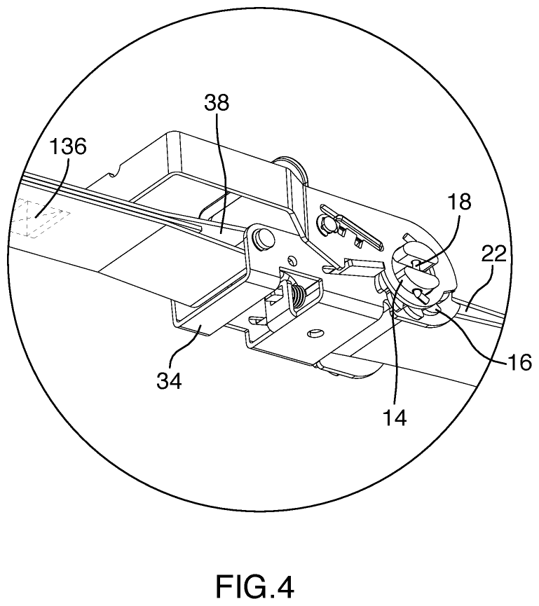

FIG. 5 is a perspective view of the device shown in FIG. 2 in an extended position.

FIG. 6 is a perspective view of the device shown in FIG. 2 with the loop 22 wrapped around the mandrel of the ratchet device.

FIG. 7 is a diagrammatic perspective view of a cargo securing device according to one implementation in use securing a load.

FIG. 8 is a diagrammatic perspective view of a cargo securing device according to another implementation in use securing a load.

### DETAILED DESCRIPTION

The present invention is directed to cargo securing strap devices. As will be discussed in detail below, preferred devices include a combination of a ratchet buckle, and one or more cam buckles permanently joined to the ratchet buckle by sewn webbing loops. The cam buckle(s) enable quick and easy tension adjustment, while the ratchet buckle provides a secure hold. The cam buckles also allow for easy adjustments of the position of the ratchet buckle before securing the load and easy release when unloading. Permanent attachments eliminate the need for, and problems associated with, threading of webbing through the ratchet buckle and cam buckles.

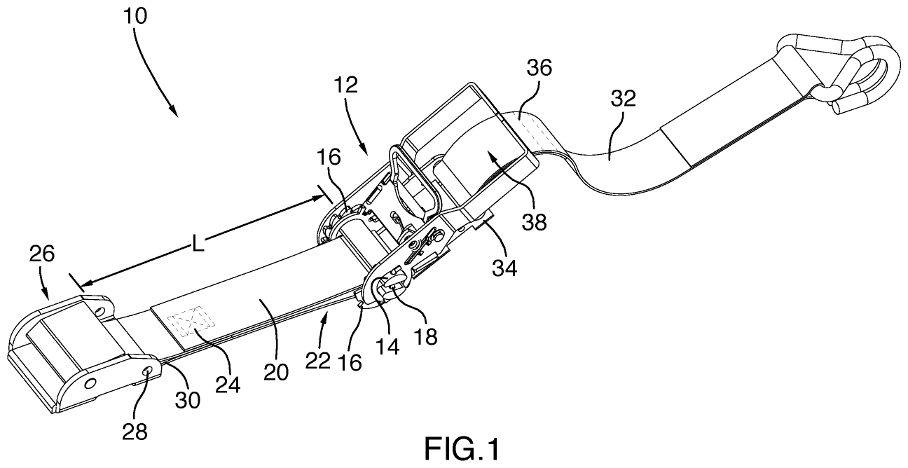

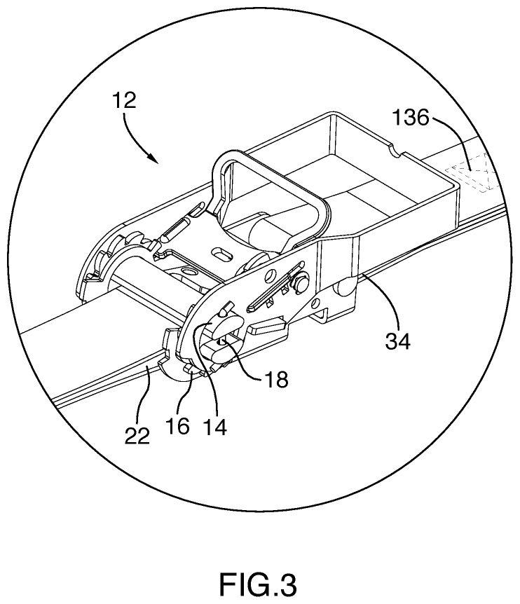

Referring to FIG. 1, in one implementation cargo securing strap device 10 includes a ratchet buckle 12 having a mandrel 14 on which ratchet wheels 16 are mounted at opposite ends as is conventional. The mandrel 14 includes an axially extending slot 18, best seen in FIG. 3, through which a webbing strap 20 is threaded, forming a loop 22. The loop 22 is fixed permanently in place on the ratchet buckle 12 by stitching 24, which may be in the form of a cross-tacking stitch, a plurality of bar tacks, or other high-strength stitching pattern commonly used to reinforce stress points on harnesses and the like.

A cam buckle 26 is attached to the webbing 20. In the embodiment shown in FIG. 1, the cam buckle 26 is attached by the same stitching used to form the loop 22. In other words, a single loop of webbing 20 is threaded through the slot 18 on the ratchet buckle 12 and also around a back rail 28 of the cam buckle 26 and then two loops are formed by stitching 24, loop 22 described above and a loop 30 that permanently attaches the cam buckle 26 to the ratchet buckle 12. The permanently sewn loops on the ratchet buckle and the attached cam buckle eliminate the need for threading the ratchet, and thus the opportunity for mis-threading.

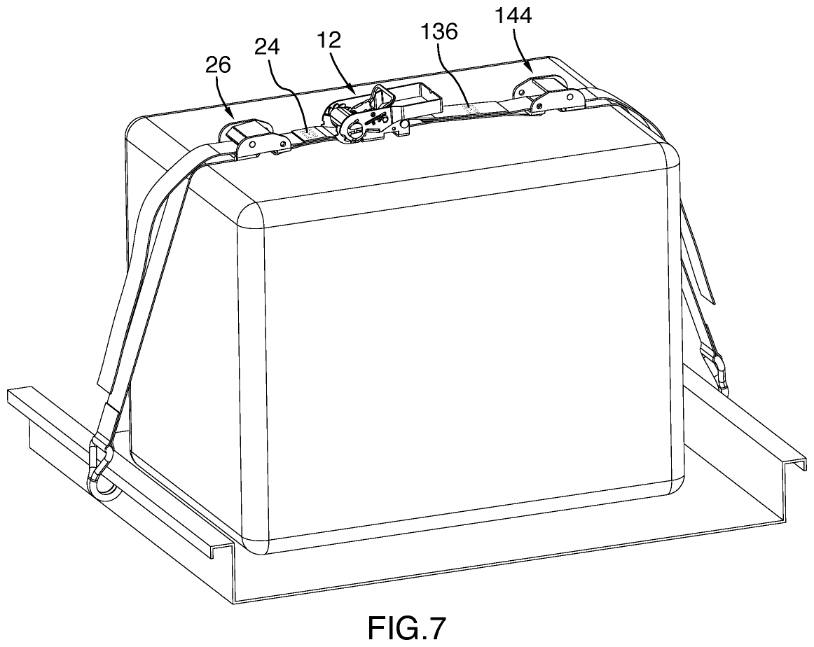

As is well known, a length of webbing (not shown) having any desired end attachment (loop, hook, etc.) would be threaded through the front rail of the cam buckle 26 for use in securing a load, for example as shown in FIG. 7.

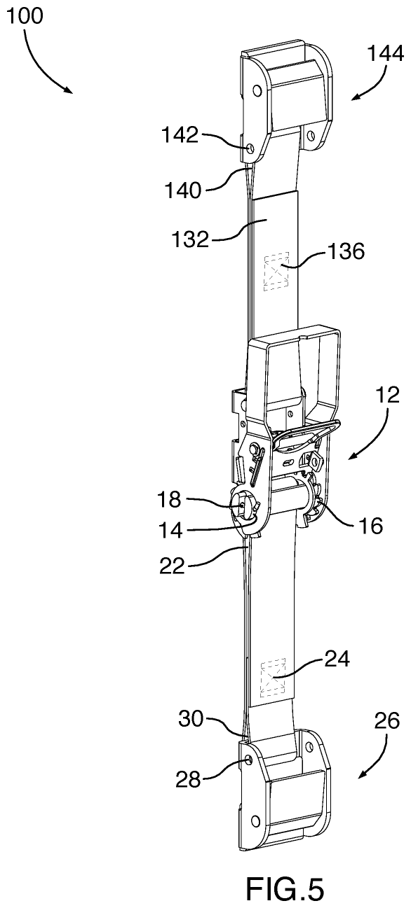

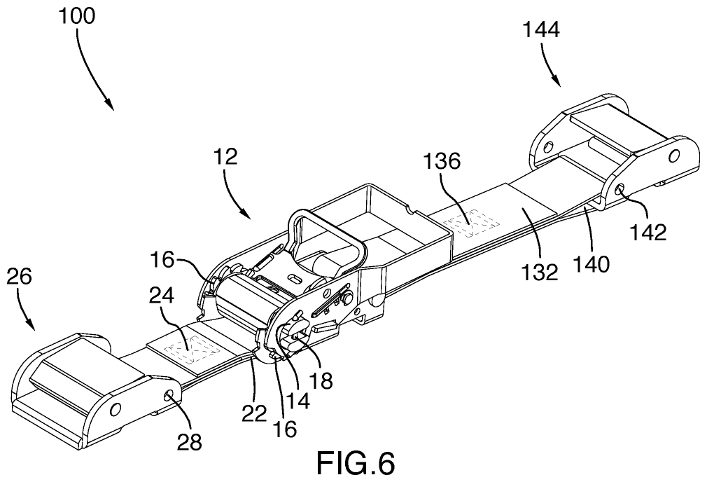

The unstitched area of the loop 22 is sufficiently long to allow the webbing of the loop to be rolled around the mandrel by the ratchet mechanism to tighten the device 10 and secure a load, from the extended position shown in FIG. 5 to the tightened position shown in FIG. 6. Having a pre-threaded, sewn loop of predetermined, fixed length avoids the problem of a user wrapping too much strap onto the ratchet mandrel, potentially creating a dangerous condition. In some implementations the length L, measured from the back rail 28 of the cam buckle 26 to the axle of the mandrel 14 as shown in FIG. 1, may be from about 2 to 7 inches, preferably about 3 to 6 inches. A length within this range serves to prevent an excessive amount of strap material from being wrapped around the mandrel during use.

In the embodiment shown in FIG. 1, a second webbing strap 32 is threaded around a rear bracket 34 of the ratchet buckle 12 and permanently secured to the rear bracket by stitching 36 which forms a loop 38 containing the rear bracket 34. The webbing strap 32 may be of any desired length and may include any desired end attachment, for example the hook 40 shown in FIG. 1.

The webbing straps 20 and 32 preferably have a width that is selected to be substantially equal to the length(s) of the mandrel 14 and rear bracket 34, respectively, leaving a slight clearance (e.g., less than 0.25 inch) to allow the loops to rotate freely about the mandrel and bracket.

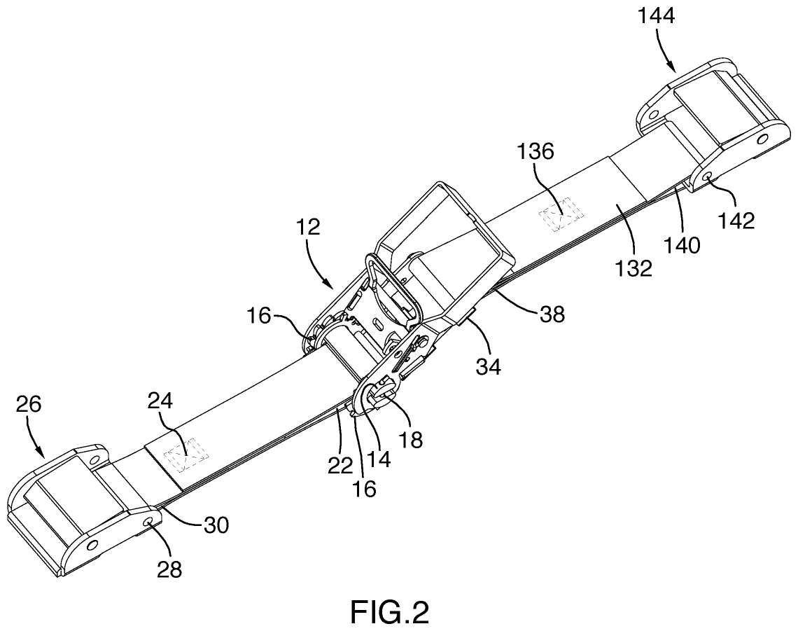

In another embodiment, shown in FIG. 2, a device 100 is similar to the device shown in FIG. 1 except that webbing strap 32 is replaced by webbing strap 132. Webbing strap 132 is threaded through rear rail 142 of a cam buckle 144 and secured by stitching 136. Stitching 136, which forms loop 38 around the rear bracket 34 of the ratchet buckle also forms a separate loop 140 around the rear rail 142. Loop 140 secures cam buckle 144 permanently to the ratchet buckle 12.

With these two cam buckles 26 and 144, one on each side of the ratchet buckle 12, a user can adjust the placement of the ratchet buckle 12 on the load for optimal securing of the load. The user can also change the way in which the device 100 is attached to a load carrier (truck or other vehicle) by threading a strap having an alternate end attachment (hook, loop, D-ring, E track fastener, etc.) through one or both of the cam buckles depending on need.

When using the devices 10 and 100 described above, the user first adjusts the strap tension with one or both cam buckles and then uses the leverage of the ratchet to secure the load. The user may also use the cam buckles to adjust the location of the ratchet buckle on the load. For example, as shown in FIG. 7 it is advantageous to position the ratchet buckle so that it is not located on a corner or other feature of the load that does not provide a suitable flat surface for it to rest on. It is also generally preferred that the cam buckles be adjusted so that they do not sit on a corner of the load. Having the combination of ratchet and cam buckles allows this adjustment to be easily made. To release the load for unloading, the user simply releases tension from one or both of the cam buckles. In the example shown in FIG. 7 once the tension is released the device can be easily removed from the load by unhooking the hooks from their attachment points.

The webbing strap can be made of weather-resistant material, such as UV-resistant or water-resistant material, to increase its durability for outdoor use. The straps to be threaded through the cam buckles may be color-coded for different loads, uses, and identification.

### OTHER EMBODIMENTS

A number of embodiments have been described. Nevertheless, it will be understood that various modifications may be made without departing from the spirit and scope of the disclosure.

For example, the straps threaded through the cam buckles can have various end attachments, such as hooks, loops, D-rings, fasteners for attaching to various types of rails or other attachment points, and the like. Moreover, in implementations where there are two cam buckles the straps threaded through them can have the same or different end attachments. This allows the system to be customized for specific uses, allowing for customization to suit various cargo needs by simply threading the appropriate end strap (the same or different) through one or both cam buckles.

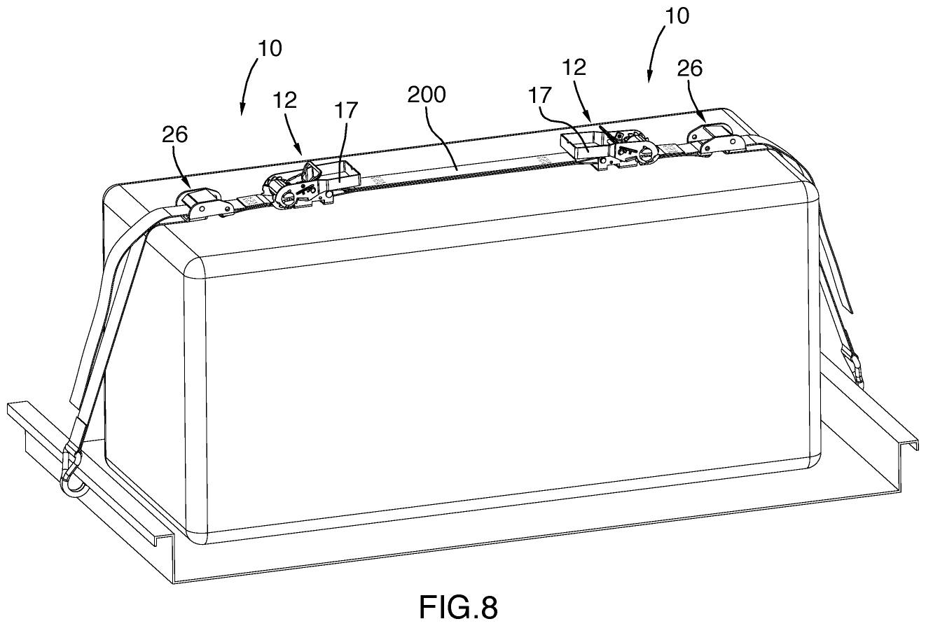

Moreover, in some implementations a pair of devices may be joined together, providing a second ratchet buckle, for example for large loads such as over the top of a semi-trailer. An example of such an implementation is shown in FIG. 8 in which a device 10 including a ratchet buckle 12 and cam buckle 26 is provided on either side of a large load. The two devices 10 are joined together by a sewn length of webbing 200 such that the combined device spans the width of the load and a user can adjust the tightness of the load from either side of the load without having to walk around to the other side. In the implementation shown in FIG. 8 the handles 17 of the ratchet buckles face each other and face away from the cam buckles to facilitate tightening from either end of the load.

Accordingly, other embodiments are within the scope of the following claims.

What is claimed is:

1. A cargo securing strap device comprising:
a ratchet buckle comprising a body, mounted on a first side of the body, a mandrel having an axially extending slot and a ratchet/pawl mechanism mounted on a first side of the body, and an elongated rear bracket mounted on a second side of the body;
a first cam buckle having a camming mechanism at a first end and a back rail at a second end; and
a loop of webbing, threaded through the slot in the mandrel of the ratchet buckle and around the back rail of the first cam buckle and secured so that the webbing is permanently threaded around the mandrel of the ratchet buckle and around the back rail of the cam buckle, and the ratchet buckle and first cam buckle are thereby permanently connected.

2. The device of claim 1 wherein the loop of webbing is secured by stitching.

3. The device of claim 2 wherein the stitching is disposed between the ratchet buckle and the cam buckle.

4. The device of claim 3 wherein the stitching is configured to provide a portion of webbing of fixed length that can be wrapped around the mandrel during use.

5. The device of claim 1 further comprising a second cam buckle and a second loop of webbing, the second loop of webbing being threaded through the elongated rear bracket of the ratchet buckle and a back rail of the second cam buckle and secured so that the second loop of webbing is permanently threaded through the elongated rear bracket of the ratchet buckle and around the back rail of the second cam buckle, and the ratchet buckle and second cam buckle are thereby permanently connected.

6. The device of claim 1 further comprising a length of webbing threaded through the camming mechanism of the first cam buckle.

7. The device of claim 6 wherein the length of webbing includes an end attachment configured to secure the length of webbing to an attachment point.

8. The device of claim 7 wherein the end attachment is a fastening device selected from the group consisting of loops, hooks, rings, and fasteners configured to be attached to rails.

9. The device of claim 5 further comprising a first length of webbing threaded through the camming mechanism of the first cam buckle and a second length of webbing threaded through the camming mechanism of the second cam buckle.

10. The device of claim 9 wherein each length of webbing includes an end attachment configured to secure the length of webbing to an attachment point.

11. The device of claim 10 wherein each end attachment is a fastening device selected from the group consisting of loops, hooks, rings, and fasteners configured to be attached to rails or other attachment points.

12. The device of claim 11 wherein the end attachments are the same.

13. The device of claim 5 wherein the second loop of webbing is secured by stitching.

14. The device of claim 4 wherein the portion of webbing that can be wrapped around the mandrel during use has a length between 3 and 6 inches.

15. A cargo securing strap device comprising:
a pair of devices, each device comprising (a) a ratchet buckle comprising a body, mounted on a first side of the body, a mandrel having an axially extending slot and a ratchet/pawl mechanism mounted on a first side of the body, and an elongated rear bracket mounted on a second side of the body; (b) a first cam buckle having a camming mechanism at a first end and a back rail at a second end; and (c) a loop of webbing, threaded through the slot in the mandrel of the ratchet buckle and around the back rail of the first cam buckle and secured so that the webbing is permanently threaded around the mandrel of the ratchet buckle and around the back rail of the cam buckle, and the ratchet buckle and first cam buckle are thereby permanently connected; and
a length of webbing permanently connected at a first end to the rear bracket of the ratchet buckle of one of the devices, and permanently connected at a second end to the rear bracket of the ratchet buckle of the other device, joining the devices such that the ratchet/pawl mechanisms of the devices face away from each other.

16. A method of securing a cargo load, the method comprising:
providing a cargo securing strap device comprising:
(a) a ratchet buckle comprising a body, a mandrel having an axially extending slot and a ratchet/pawl mechanism mounted on a first side of the body, and an elongated rear bracket mounted on a second side of the body;
(b) a first cam buckle having a camming mechanism at a first end and a back rail at a second end;
(c) a first loop of webbing, threaded through the slot in the mandrel of the ratchet buckle and around the back rail of the first cam buckle and secured so that the webbing is permanently threaded around the mandrel of the ratchet buckle and around the back rail of the cam buckle, and the ratchet buckle and first cam buckle are thereby permanently connected;
(d) a second cam buckle having a camming mechanism at a first end and a back rail at a second end; and
(e) a second loop of webbing, the second loop of webbing being threaded through the elongated rear bracket of the ratchet buckle and a back rail of the second cam buckle and secured so that the second loop of webbing is permanently threaded through the elongated rear bracket of the ratchet buckle and around the back rail of the second cam buckle, and the ratchet buckle and second cam buckle are thereby permanently connected;
threading a first length of webbing through the camming mechanism of the first cam buckle;
threading a second length of webbing through the camming mechanism of the second cam buckle;
securing ends of the first and second lengths of webbing to attachment points at either side of a cargo to be secured;
removing slack from the first and second lengths of webbing by tightening them through the first and second camming mechanisms; and
tightening the load using the ratchet mechanism of the ratchet buckle.

17. The method of claim 16 wherein the first and second lengths of webbing include end attachments and the securing step includes attaching the end attachments to the attachment points.

18. The method of claim 16 further comprising adjusting the location of the ratchet buckle on the cargo load by tightening and/or loosening the cam buckles.

19. The method of claim 16 further comprising releasing the load by releasing tension from one or both of the lengths of webbing using the camming mechanisms.
